(19) United States
(12) Patent Application Publication
(10) Pub. No.: US 2004/0025650 A1
(43) Pub. Date: Feb. 12, 2004

(54) Turning head of precision screwdriver

(76) Inventor: Cheng-Tsan Hu, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/215,006

(22) Filed: Aug. 9, 2002

(51) Int. Cl. B25G 1/08

(52) U.S. Cl. 81/490

(57) ABSTRACT

A structure of turning head of a precision screwdriver provides an accommodation space inside a handle opening to one end in wider diameter, a holder in the accommodation space, a plurality of ribs each with a locking trough formed in the holder to hold a plurality of tips, and both ends of the holder are connected to form a pivot and a fender; the pivot is pivoted to the center of the turning head; a circular protrusion and a groove are provided at where the turning head contacts the accommodation space of the handle with both connected to each other for free pivoting and the turning head functioning as a support axle for the handle, the holder is exposed by pulling the turning head linked to the pivot and is restricted in the circular groove of the accommodation space by the fender.

### BACKGROUND OF THE INVENTION

(a) Field of the Invention

The present invention relates to a structure of a turning head of a precision screwdriver, and more particularly, to one that allows the turning head to achieve agile rotation relatively to the handle of the screwdriver.

(b) Description of the Prior Art

Whereas, a precision screwdriver generally available in the market has its handle fixed or disposed with an interchangeable tip at a smaller end of the handle and is incorporated at another end of the handle with an axially pivoted handle. In use, one has his index finger to hold against the handle at the upper end of the handle and his thumb and another three fingers to hold the handle with the tip aiming at a screw with the handle as an axle to support rotation while rotating the handle by his thumb and other three fingers thus to turn and tighten or loosening the screw depending on the turning direction.

One of the prior art is essentially taking advantage of the space in the body of the handle to be incorporated with a retractable holder to receive and hold multiple exchangeable tips in position. Wherein, the rotation axle required in the use of the precision screwdriver is taken into consideration, and the space inside the handle is open to its end in a wider diameter to place the holder and ribs provided with locking troughs are longitudinally disposed in the middle section of the holder to clamp multiple tips. Both ends of those ribs are connected to define a circular shaft and a fender with the accommodation space in relation to the circular shaft having at its inner edge in the opening end to form protrusion wall and circular protrusion for temporary holding, and the extended end of the circular shaft in relation to the handle is provided to be engaged by a turning cap. Locking rings detachably pivoted to each other are respectively provided inside the cap and the circular shaft so to have the turning head functioning as a support axle for the handle of the screwdriver. By pulling the turning head, the protrusion wall clears away from the circular protrusion thus to consequently pull the holder out of the handle and the holder holds against the circular protrusion by the fender to all the exchange of the tips from the holder.

However, certain insufficiencies are observed from the prior art with their causes summarized as follows:

In use, one has his index finger to press the turning head while using his thumb and middle finger to turn the handle either to tighten up or loosening up the screw. Therefore when the handle rotates in relation to the turning head, the handle will cause the circular shaft to rotate relatively to the turning head. Since the circular shaft is connected to both of the turning head and the handle, a comparatively greater friction is created, resulting in that when the handle rotates in relation to the handle, the circular shaft and the holder at its bottom to turn at the same time. As multiple tips are caught in place on the holder making the total weight very heavy and the use of the screwdriver rather awkward when more strength is required to rotate the handle relative to the rotation by the turning head.

### SUMMARY OF THE INVENTION

The primary purpose of the present invention is to provide a structure of a turning head for a precision screwdriver to achieve a well-facilitated turning of the handle. To achieve the purpose, a space for accommodation inside the handle with one end open toward the end of the handle in a wider diameter. A holder is disposed inside the space and a plurality of ribs each provided with a locking trough to receive the tip, and both ends of the holder are respectively connected to form a pivot and a fender characterized by that:

the pivot is pivoted at the center of the turning head while a circular protrusion and a groove are provided on where the accommodation space of both of the turning head and the handle contacts so that both are connected and allowed to freely pivot. Accordingly, the turning head functions as a support axle for the handle of the screwdriver and when the turning head is pulled, the pivot linked to the turning head pulls out the holder out of the handle and the holder is limited in position by having the fender to hold against the circular groove.

### BRIEF DESCRIPTION OF THE DRAWINGS

FIG. 1 is an exploded view showing a structure of a preferred embodiment of the present invention.

FIG. 2 is a sectional view of the preferred embodiment of the present invention.

FIG. 2A and FIG. 2B are partially enlarged views of FIG. 2.

FIG. 3 is a sectional view showing that the chamber of the preferred embodiment of the present invention is pulled out.

FIG. 3A is a partially enlarged views of FIG. 3.

### DETAILED DESCRIPTION OF THE PREFERRED EMBODIMENTS

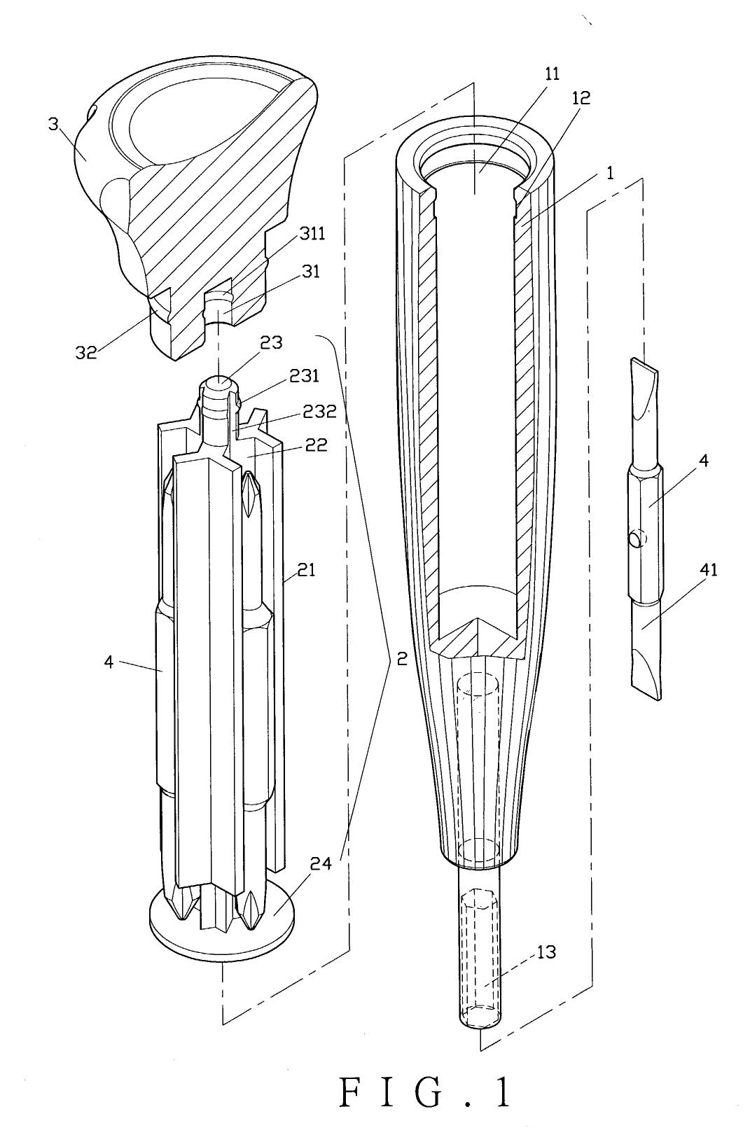

Referring to FIG. 1, a preferred embodiment of the present invention comprises a handle (1), a holder (2), a turning head (3) and a plurality of tips (4). An accommodation space (11) opening to one end in wider diameter is provided inside the handle (1). The holder (2) is placed in the accommodation space (11) with a circular groove (12) provided on the inner edge of the open end of the accommodation space (11) and a hexagonal trough (13) is provided in a section of reduced diameter of the handle (1) for axial insertion of the tip (4).

A plurality of ribs (21) for segregating the space are formed in the middle section of the holder (2), a plurality of locking troughs (22) are provided on the ribs (21) to hold the tips (4) in position. Both ends of the rib (21) respectively are formed into a pivot (23) and a fender (24) with the outer circumference of the pivot (23) formed a course of protrusion wall (231) and a plurality of slots (232) are provided on the pivot (23) while the fender (24) is made in a shape of a shovel.

An insertion hole (31) is provided at the very center of the turning head (3), a course of groove (311) is formed in the inner circumference of the insertion hole (31) in relation to the protrusion wall (231) of the pivot (23) with the turning head (3) detachably pivoted relatively to the pivot (23) so to engage in free rotation. A circular protrusion (32) extends from the outer circumference of the turning head (3) in relation to the circular groove (12) in the inner circumference of the accommodation space (11).

Each of the tips (4) is a hexagonal rod having at its both ends formed respectively two ends (41) in different type or size.

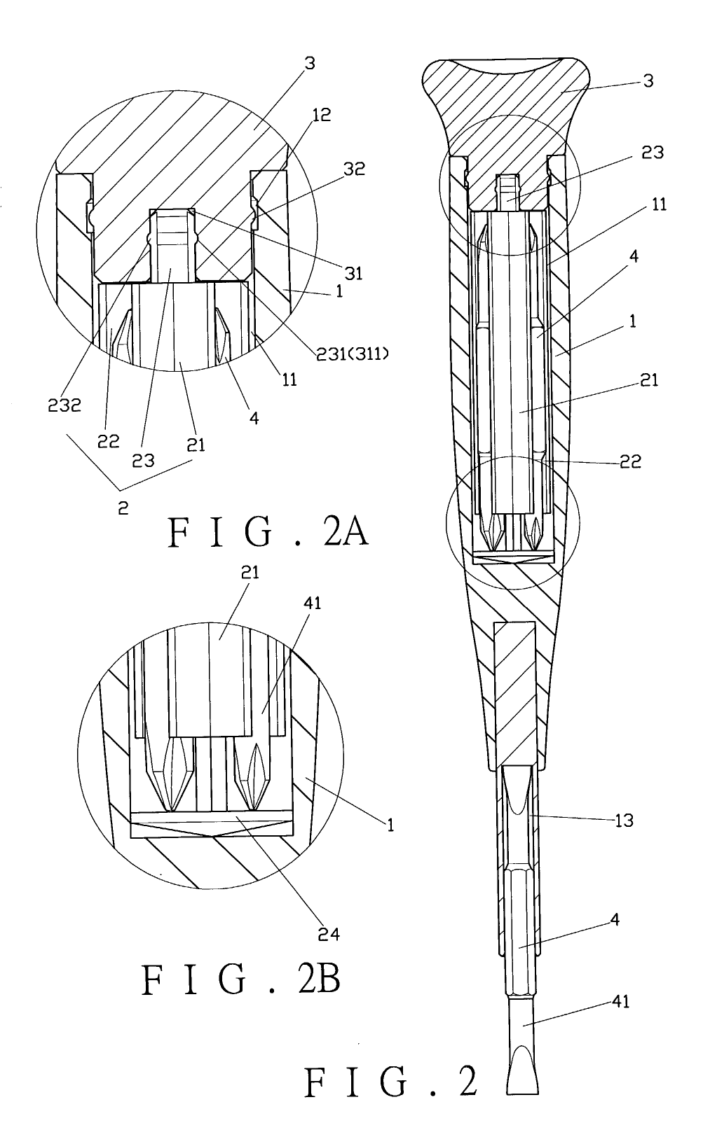

As illustrated in FIG. 2, the turning head (3) is inserted in relation to the pivot (23) by means of the insertion hole (31) with the protrusion wall (231) merely inserted and restricted in the groove (311) so that the holder (2) is pivoted to the bottom of the turning head (3), then force is exercised to push in the holder (2) by the fender (24) provided at the lower end along the circular groove (12) at the inner circumference in the open end of the accommodation space (11) of the handle (1) and the tips (4) are pushed into the locking trough (22) on the rib (21) to be held in position. When the holder (2) extends in relation to the accommodation space (11), the holder (2) is held in position by connecting both of the circular protrusion (32) of the turning head (3) and the circular groove (12) inside the accommodation space (11) so that the holder (2) is concealed in the accommodation space (11). The turning head (3) functions as the support axle for turning the handle (1). Since the pivot (23) is pivoted at the center of the turning head (3), it does not contact the handle (1). The slots (232) are provided on the circumference of the pivot (23) to reduce the contact area with the insertion hole (31) of the turning head (3). Therefore, upon turning the turning head (3), only the turning head (3) rotates in relation to the pivot (23) while the holder (2) remains being positioned in the accommodation space (11) without moving. Furthermore, the circular groove (12) on the inner circumference of the accommodation space (11) and the circular protrusion (32) from the turning head (3) are loosely adapted to each other. Therefore, once the handle (1) rotates in relation to the turning head (3), only an extremely rotation resistance is met to warrant smooth rotation. In addition, another end of the handle (1) is in reduced diameter, the hexagonal trough (13) is provided to receive the insertion of the tip (4) so to complete a precision screwdriver that contains a plurality of spare tips (4) and that allows smooth drive of a selected tip (4) by turning the handle (1).

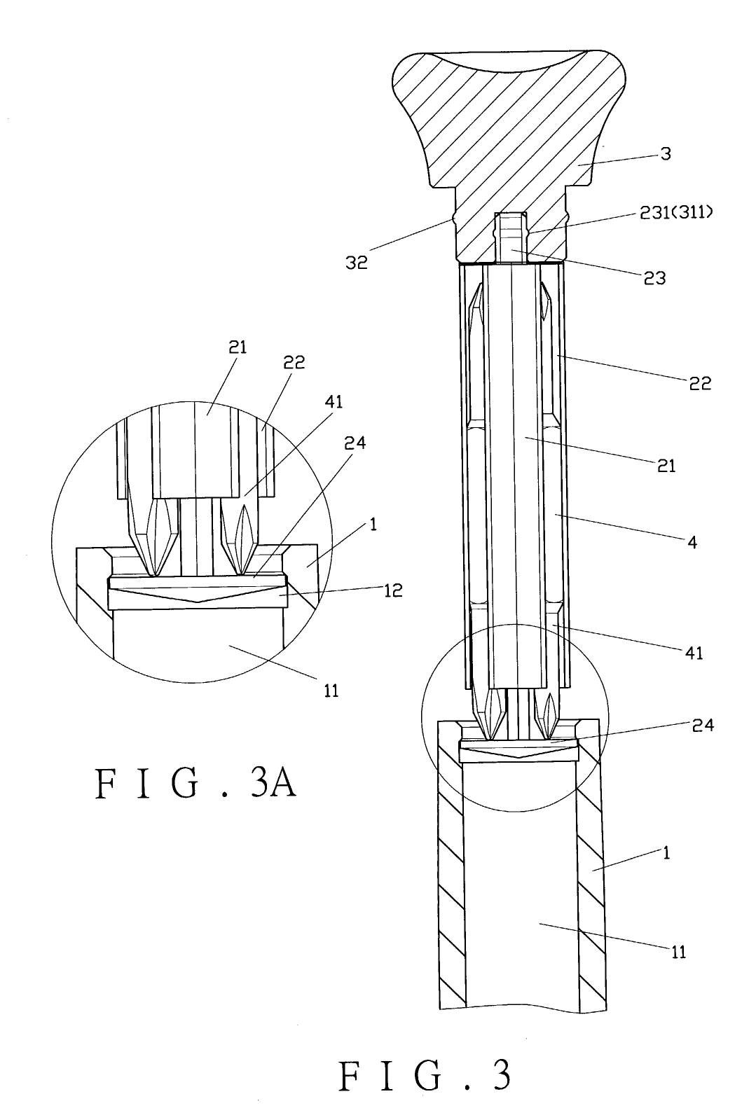

Now referring to FIG. 3 when a replacement of another tip (4) is required, the turning head (3) is pulled to move the holder (2) for the circular protrusion (32) to clear away from the circular groove (12) at the inner circumference of the accommodation space (11) in the handle (1). When the holder (2) is fully pulled out, the fender (24) engages with the circular groove (12) of the handle (1), it is restricted in and prevented from accidental fall out of the accommodation space (11). The tips (4) each held in the locking trough on the rib (21) of the holder (2) are exposed for selection to be exchanged with the existing one inserted in the hexagonal trough (13) in the section of reduced diameter of the handle (1).

1. A structure of turning head of a precision screwdriver, essentially comprising an accommodation space provided inside a handle of the precision screwdriver opening to one end in wider diameter, a holder in the accommodation space, a plurality of ribs each with a locking trough formed in the middle section of the holder to hold a plurality of tips, and both ends of the holder being connected to respectively form a pivot and a fender, characterized by that:
the pivot being pivoted to the center of the turning head, a circular protrusion extending from the outer circumference of the turning head in relation to a circular groove in the inner circumference of the accommodation space, both of the turning head and the handle being connected to each other for free pivoting, the turning head functioning as a support axle for the handle, the holder being exposed by pulling the turning head linked to the pivot, and the exposed holder being restricted in the circular trough of the accommodation space by means of the fender.

2. A structure of turning head of a precision screwdriver as claimed in claim 1, wherein, a protrusion wall is provided on the circumference of the pivot, a groove is formed in the turning head in relation to the protrusion wall of the pivot; and both of the turning head and the pivot are connected to each other so to engage in free rotation.
